(19) United States
(12) Patent Application Publication
(10) Pub. No.: US 2021/0178519 A1
(43) Pub. Date: Jun. 17, 2021

(54) METHOD FOR PRODUCING A WELDING ASSEMBLY, AND WELDING ASSEMBLY

(71) Applicant: Brose Fahrzeugteile SE & Co. Kommanditgesellschaft, Würzburg, Würzburg (DE)

(72) Inventors: Dominik FENTEN, Güntersleben (DE); Michael SCHULZE, Karlstadt (DE); Julian SCHMITT, Würzburg (DE); Ralph KALTHOFF, Kürnach (DE)

(73) Assignee: Brose Fahrzeugteile SE & Co. Kommanditgesellschaft, Würzburg, Würzburg (DE)

(21) Appl. No.: 17/055,312

(22) PCT Filed: May 13, 2019
(86) PCT No.: PCT/EP2019/062181

§ 371 Date: Nov. 13, 2020

(30) Foreign Application Priority Data
May 14, 2018 (DE) 10 2018 207 439.9

(51) Int. Cl. B23K 26/323; C22C 21/02

(52) U.S. Cl. CPC B23K 26/323; B23K 2103/10; C22C 21/02

(57) ABSTRACT

The invention relates to a method for producing a welding assembly (2, 8), in particular a housing of an electrical machine (1). A first, cold-formed joining partner (2), which is formed from a cold-formable first aluminium alloy having a low silicon content, and a second joining partner (8) formed from a second aluminium alloy having an increased silicon content as compared to the first aluminium alloy are provided. Said joining partners are joined by means of laser beam welding. The silicon content of the second aluminium alloy is increased relative to the first aluminium alloy in such a way that a silicon content of at least approximately 3% is provided in a welding zone (74) between the first and the second joining partner (2, 8).

### CROSS-REFERENCE TO RELATED APPLICATIONS

This application is the U.S. National Phase of PCT Application No. PCT/EP2019/062181 filed on May 13, 2019, which claims priority to German Patent Application No. DE 10 2018 207 439.9, filed on May 14, 2018, the disclosures of which are hereby incorporated in their entirety by reference herein.

### TECHNICAL FIELD

The present disclosure relates to a method for producing a welding assembly, the parts to be joined of which are each formed from an aluminum alloy for use in an electric machine, for example.

### BACKGROUND

Welding assemblies are often used whenever the use of additional components, for example connecting elements such as screws, is to be avoided. This is so because, under some circumstances, the increase in weight of the overall assembly caused by such additional connecting elements may be undesired. Furthermore, in the case of the use concerned here a welded connection may also be more appropriate for the loading involved.

For the case where the welding assembly is formed from aluminum components, there are often various problems that have to be taken into account. Thus, for example, for mass production of individual components, it is expedient from an aspect of cost-effectiveness to produce them by cold forming, in particular cold extrusion. As a result, comparatively great dimensional accuracy is possible, but at the same time a high-quality surface finish and no or only little reworking effort. However, aluminum alloys that can be welded well, such as for example AlMg3, cannot be processed with sufficient degrees of freedom by means of cold forming. Aluminum alloys that are particularly well-suited for cold forming can in principle be welded, but they often have a tendency for so-called hot cracks, which may lead to destruction of the welding assembly during operation. This is the case in particular for aluminum alloys with a mass content of approximately one percent silicon. With such a silicon content, aluminum alloys have an increased tendency to develop hot cracks.

In the production of a welded connection between two components which each have for example a silicon content of approximately 1 percent, therefore a welding filler material is usually fed to the welding zone (also: “melting zone”), in order to alloy it beyond the critical silicon content. This however involves a comparatively great amount of additional effort, since the filler material usually has to be fed in the form of a wire, for which reason, in automated production, camera monitoring of the wire feed is usually required.

### SUMMARY

The present disclosure may be based on a number of objects such as simplifying the production of a welding assembly.

According to one embodiment, a method of producing a welding assembly, such as a housing of an electric machine. According to the method, in this case a first, cold-formed (such as cold-extruded) part to be joined is provided, formed from a first aluminum alloy with a low silicon content that can be cold-formed or is suitable for cold extrusion. Also provided is a second part to be joined, formed from a second aluminum alloy, which has an increased silicon content in comparison with the first aluminum alloy. The first part to be joined and the second part to be joined are then joined to one another, for example directly (i.e. without additional components being placed in between) by means of laser beam welding. The silicon content of the second aluminum alloy is in this case set to e.g., selected such an increased level in comparison with the first aluminum alloy that a silicon content of at least approximately 3 percent (for example percent by mass) is obtained in a welding zone between the first part to be joined and the second part to be joined.

As an example, the silicon content of the second aluminum alloy is set (chosen) in such a way that after the laser beam welding there is a silicon content of at least approximately 4 percent in the welding zone.

With respect to specified percentages of the (mass-related) alloy components, the term “approximately” is understood here and hereinafter as meaning that there can be a tolerance range of +/−0.5 percent.

The use of laser beam welding may make it possible to be able to align the two parts to be joined freely in relation to one another, such as without having to make allowance for joining elements fixedly provided on at least one of the parts to be joined, for example screw holes, locating pins or the like. As an example, this makes it possible to be able to compensate for positional tolerances, which depend inter alia on the positioning (or: alignment) of the parts to be joined in relation to one another. For example, an axis alignment, an eccentricity or else concentricity and the like can be compensated or set particularly easily, for example in the case of bearing mountings formed by the two parts to be joined.

In the welding process, it is recognized that melting of the two parts to be joined occurs at the locations where they are joined, and consequently also a local mixing of the materials of the two parts to be joined. With a silicon content from approximately 3 percent, the risk of formation of hot cracks falls. On account of the previously described choice, in particular setting, of the second aluminum alloy with respect to its silicon content, and the accompanying alloying in the welding zone to the silicon content of at least approximately 3, such as 4, percent, the risk of the formation of hot cracks can therefore be advantageously lowered or even avoided. As an example, it is thereby also made possible to use as the first aluminum alloy for the first part to be joined an aluminum alloy that may be well-suited for cold forming and often has a relatively low silicon content—for example of below 2 percent—and consequently a strong tendency for the formation of hot cracks. As a result, the first part to be joined can be produced cost-effectively, and nevertheless the risk of the formation of hot cracks during joining by welding can be lowered without increasing the effort involved in production. The latter is advantageously made possible by being able to dispense with the use of a welding filler material of a high silicon content on account of the previously described alloying of the welding zone by the second aluminum alloy.

As an example, the laser beam welding is also carried out without such a welding filler material. This may dispense the effort required for wire feeding, and accompanying monitoring of the welding process with regard to the wire feeding, and also the material costs for the welding filler material.

In one or more embodiments, an aluminum alloy, such as a cast aluminum alloy, with a silicon content of at least approximately 8 percent, such as of at least 10 percent, is used for the second part to be joined (and consequently as a second aluminum alloy). With this silicon content, the previously described alloying of the welding zone is made possible, such as with a comparatively high level of reliability of the process. Used in this case as the second aluminum alloy is for example AlSi12 (also known by the designation EN AC 44300) or AlSi12Cu1 (also known by the designation EN AC 47100).

As an example, an aluminum alloy, such as a wrought aluminum alloy, with a silicon content of approximately 1 percent is used as the first aluminum alloy (i.e. for the first part to be joined). For example, AlMgSi1 (also known by the designation EN AW 6082) is used as the first aluminum alloy.

As another example, the second part to be joined is produced by means of aluminum diecasting. This provides particularly great freedom of design for the second part to be joined (such as with regard to the component geometry) with at the same time cost-effective mass production.

The welding assembly according to one or more embodiments, a housing of an electric machine, for example an electric motor is provided. The welding assembly in this case comprises the previously described first, cold-formed part to be joined, which is formed from the first cold-formable aluminum alloy with a low silicon content. The welding assembly also comprises the second part to be joined, which is formed from the second aluminum alloy with the increased silicon content and is joined to the first part to be joined by means of a laser beam welding process. The increased silicon content of the second aluminum alloy is in this case chosen such that in the welding zone between the first part to be joined and the second part to be joined the silicon content of at least approximately 3 percent, such as of at least approximately 4 percent, is formed. That is to say that the welding assembly according to the invention is produced such as by means of the previously described method.

The welding assembly consequently has all of the (physical) features arising from the previously described method. Consequently, the method and the welding assembly also share the corresponding, previously described advantages.

In another embodiment, the first part to be joined is a housing case, which forms such as a pot-like part of the housing of the electric machine. The second part to be joined is in this case an end shield that closes off the end face of the housing case. The end shield in this case serves such as for the mounting of a bearing for a rotor shaft of the electric machine, which in the intended assembled state of the electric machine inside the housing case is connected to a rotor and is mounted rotatably with respect to a stator.

The electric machine may be a component part of a motor vehicle such as a component part of an auxiliary unit of the motor vehicle, such as an adjusting drive. As an example, the electric machine is a component part of a pump, such as a lubricant pump, such as an engine oil or transmission oil pump. As an alternative to this, the electric machine is a component part of a water pump, an air-conditioning compressor or a heater fan (HVAC). In an alternative to this, the electric machine is a component part of an electrical window lifter, an electromotive seat adjustment, an electromotively operated tailgate or an electric sliding roof. In a further alternative, the electric machine is a component part of a massaging device of a vehicle seat. The electric machine may be an electric motor, for example a synchronous motor. For example, the electric motor is a commutator motor with brushes. In another embodiment, the electric motor is of a brushless design, such as a brushless DC motor (BLDC). As an example, the electric machine is a steering motor, and consequently a component part of a steering device of the motor vehicle. Here, during operation, a steering rod is moved as an adjusting part, such as by means of the electric motor.

### BRIEF DESCRIPTION OF THE DRAWINGS

An exemplary embodiment of the invention is explained in more detail below on the basis of a drawing, in which:

FIG. 1 schematically shows in a perspective front view a welding assembly which forms a housing of an electric machine,

FIG. 2 shows in a perspective rear view the welding assembly according to FIG. 1, FIG. 3 shows a schematic longitudinal section of the welding assembly, and

FIG. 4 shows in a schematic flow diagram a method for producing the welding assembly.

Parts corresponding to one another are always provided with the same reference signs in all of the figures.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

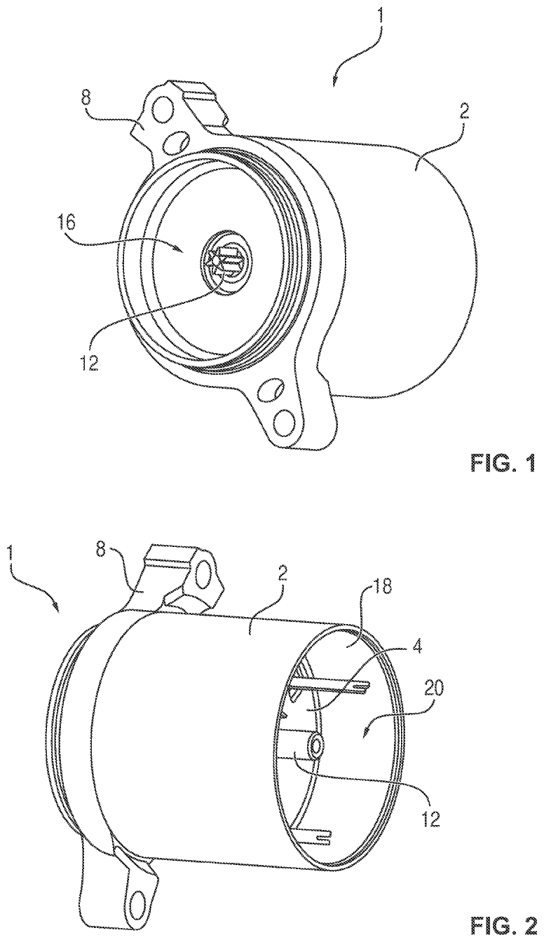

Perspectively represented in FIGS. 1 and 2 is an electric machine, specifically an electric motor 1. The electric motor 1 has a housing case, specifically a pot-shaped housing part (referred to as “housing pot 2”) with integrally formed on it a B-side end shield 4 (see FIG. 2), on which a first rolling bearing, specifically a ball bearing 6, is centrally mounted. The housing pot 2 with the B-side end shield 4 integrally formed on it is closed on the remaining side by means of an A-side end shield 8 (which likewise forms a housing part), which bears a second rolling bearing (specifically a ball bearing 10). The housing pot 2 is produced from a first aluminum alloy by means of cold forming, specifically by means of cold extrusion. The A-side end shield 8 is produced from a second aluminum alloy as an aluminum diecasting.

The electric motor 1 has a rotor shaft 12, which is mounted rotatably about an axis of rotation 14 by means of the two ball bearings 6 and 10. For coupling on the output side to a downstream transmission, the rotor shaft 12 is designed as externally toothed on the end. The A-side end shield 8 also has a recess 16, which is directed away from the housing pot 2 and serves for partially receiving the downstream transmission. Formed on the housing pot 2 on the side having the B-side end shield 4 is a projecting collar 18. A space 20 formed within the collar 18 serves for receiving a rotary emitter and drive electronics of the electric motor 1.

Mounted on the rotor shaft 12, between the two ball bearings 6 and 10, for conjoint rotation is a laminated core 22, with permanent magnets positioned in it. The laminated core 22 with the permanent magnets forms together with the rotor shaft 12 a rotor 24 of the electric motor 1. The laminated core 22 is surrounded by a stator 26, which is arranged on an inner wall of the housing pot 2 and comprises a number of electrical coils 28.

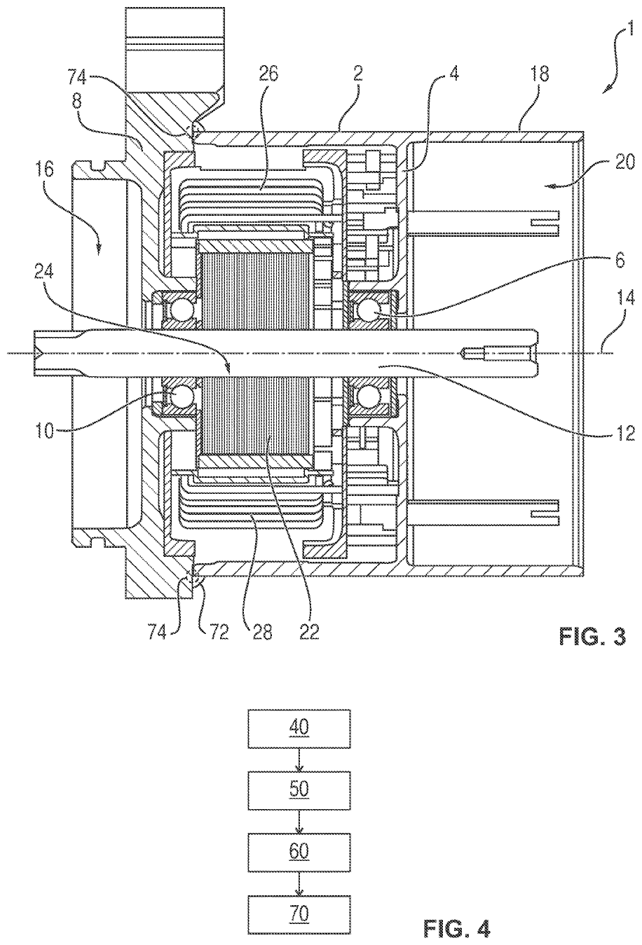

In a method described in more detail below on the basis of FIG. 4, the A-side end shield 8 is joined to the housing pot 2 by means of laser beam welding. The housing pot 2 in this case forms a first part to be joined and the A-side end shield 8 correspondingly forms a second part to be joined. The housing formed from the housing pot 2 and the A-side end shield 8 consequently represents a welding assembly. The first aluminum alloy (i.e. that of the housing pot 2) specifically has a silicon content of approximately 1 percent. It is in this case specifically a wrought aluminum alloy, for example AlMgSi1, which is particularly well-suited for cold extrusion. The second aluminum alloy (that is to say that of the A-side end shield 8) specifically has a silicon content of greater than 10 percent. The second aluminum alloy is specifically a cast aluminum alloy, for example AlSi12.

In a first method step 40 of the method represented in FIG. 4, the housing pot 2 is provided with the stator 26. Before the first method step 40, the housing pot 2 was produced from the first aluminum alloy in a cold extrusion process, the stator 26 was placed within the housing pot 2 and connected to its inner wall. Moreover, the first ball bearing 6 has been connected to the B-side end shield 4.

In a second method step 50, the rotor 24 is introduced into the housing pot 2, and consequently into the stator 26. The rotor shaft 12 is thereby led through the first ball bearing 6, so that the rotor shaft 12 protrudes into the space 20.

In a third method step 60, the A-side end shield 8, which bears the second ball bearing 10, is placed onto the housing pot 2. The rotor shaft 12 is thereby threaded into the second ball bearing 10. The A-side end shield 8 is first placed flat and just loosely onto the end face of the housing pot 2 opposite from the B-side end shield 4 and the space 20. Then the A-side end shield 8 is aligned with the housing pot 2—optionally iteratively—in such a way that there is as far as possible undisturbed mounting of the rotor 24 with respect to the stator 26. Specifically, the A-side end shield 8 is displaced transversely in relation to the axis of rotation 14, while determining disturbances, for example an eccentricity of the rotor 24 in relation to the stator 26, a cogging torque of the rotor 24 and/or an (electromotive) force acting on the rotor 24, which occurs when current is applied to at least some of the electrical coils 28, so that a distance between the laminated cores 22 of the rotor 24 and the coils 28 of the stator 26 also changes. This leads in turn to changing of the aforementioned disturbances.

In a subsequent method step 70, the A-side end shield 8 is fastened on the housing pot 2 in a position with sufficiently low disturbances. For this, the A-side end shield 8 is laser-welded to the housing pot 2, so that a material-bonding connection between the A-side end shield 8 and housing pot 2 is obtained along a (schematically indicated) weld seam 72. The weld seam 72 is in this case of a gas-tight design, so that penetration of foreign particles into the housing in the region of the abutting edges of the A-side end shield 8 with the housing pot 2 is prevented.

In the laser beam welding, a mixed alloy between the first aluminum alloy and the second aluminum alloy is obtained in a welding zone 74, which is formed around the laser beam impinging on the two parts to be joined. Because of the choice of the second aluminum alloy with the silicon content of greater than 10 percent for the A-side end shield 8, a silicon content which is alloyed in comparison with the first aluminum alloy (which has a silicon content of approximately 1 percent) in such a way as to reduce the hot cracking tendency of the first aluminum alloy that is inherent in the alloy is thereby obtained in the welding zone 74. Specifically, because of the use of the second aluminum alloy for the A-side end shield 8, the silicon content in the welding zone 74 increases to at least approximately 4 percent. This makes it possible to dispense with the laborious and cost-intensive use of a welding filler material and nevertheless effectively lower the risk of the formation of hot cracks.

On account of the alignment of the A-side end shield 8 and the housing pot 2, it is also not necessary for special requirements to be imposed on component tolerances at the location of the connection between the housing pot 2 and the A-side end shield 8. In this way, the production of the A-side end shield 8 and of the housing pot 2 is less costly. Furthermore, as result of the weld seam 72, no sealing elements are required, which further reduces production costs.

The subject matter of the invention is not restricted to the exemplary embodiment described above. Rather, further embodiments of the invention may be derived from the foregoing description by a person skilled in the art.

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

### LIST OF REFERENCE DESIGNATIONS

1 Electric motor
2 Housing pot
4 B-side end shield
6 Ball bearing
8 A-side end shield
10 Ball bearing
12 Rotor shaft
14 Axis of rotation
16 Recess
18 Collar
20 Space
22 Laminated core
24 Rotor
26 Stator
28 Coil
40 Method step
50 Method step
60 Method step
70 Method step
72 Weld seam
74 Welding zone

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A method of producing a welding assembly, the method comprising:
forming, by cold forming a first part formed of a first aluminum alloy provided with a first percentage of silicon;
providing a second part formed of a second aluminum alloy provided with a second percentage of silicon; and
welding by directing a laser beam at a welding zone overlapping the first part and/or the second part to join the first and second parts to one another, wherein the second percentage of silicon is greater than the first percentage of silicon so that the welding zone includes
at least approximately 3 percent of silicon.

2. The method of claim 1,
wherein the second percentage of silicon of the second aluminum alloy is at least approximately 8 percent.

3. The method of claim 1,
wherein the first percentage of silicon of the first aluminum alloy is at least approximately 1 percent.

4. The method of claim 1,
wherein the welding step is accomplished without providing a welding filler material.

5. The method of claim 1, further comprising:
forming the second part by means of aluminum diecasting before the providing step.

6. A welded assembly comprising:
a first part formed of a first aluminum alloy provided with a first percentage of silicon, wherein the first part is formed by cold-forming; and
a second part formed of a second aluminum alloy provided with a second percentage of silicon,
wherein the first part and the second part are joined to one another by means of a laser beam welding process, and wherein the second percentage of silicon of the second aluminum alloy is greater than the first percentage of silicon such that a welding zone overlapping the first part and the second part includes at least approximately 3 percent of silicon.

7. The welded assembly of claim 6,
wherein the second percentage of silicon of the second aluminum alloy is at least 8 percent.

8. The welded assembly of claim 6,
wherein the first percentage of silicon of the first part is approximately 1 percent.

9. The welded assembly of claim 6, wherein the second part is formed as by aluminum diecasting.

10. The welded assembly of claim 6,
wherein the first part is a housing pot of a housing for use in an electric machine, and the second part is an end shield that closes off an end face of the housing pot.

11. The welded assembly of claim 7, wherein the second percentage of silicon is at least 10 percent.

12. A method of assembling an electric motor, the method comprising:
cold forming a first aluminum alloy to form a housing pot provided with an A-side end and a B-side, wherein the A-side is open and B-side is closed by a B-side end shield;
attaching a stator the housing pot;
attaching a rotor to the housing pot;
inserting a rotor shaft into the rotor;
providing an A-side end shield formed of a second aluminum alloy;
placing the A-side end shield onto the A-side end of the housing pot; and
laser welding the A-side end shield to the A-side of the housing pot and forming a weld zone, wherein the first aluminum alloy includes a first percentage of silicon the second aluminum alloy contains a second percentage of silicon, wherein the second percentage of silicon is greater than the first percentage of silicon such that the weld zone includes a third percentage of silicon and wherein the third percentage of silicon is greater than or equal to 2.95%.

13. The method of claim 12, further comprising:
die-casting the second aluminum alloy to form the A-side end shield.

14. The method of claim 12, further comprising:
aligning the A-side end shield with respect to the A-side end of the housing pot by displacing the A-side end shield in a direction transverse to a rotational axis defined by the rotor shaft.

15. The method of claim 14, further comprising:
determining an eccentricity of the rotor with respect to the stator.

16. The method of claim 15, wherein the determining step is accomplished simultaneously with the laser welding step.

17. The method of claim 12, where in the inserting step includes inserting the rotor shaft into a first ball bearing coupled to the B-side end shield.

18. The method of claim 17, wherein the placing step includes threading the rotor shaft into a second ball bearing fixed to the A-side end shield.

19. The welded assembly of claim 10, wherein the housing pot includes an open-ended A-side and a B-side end plate disposed between a collar and the open-ended A-side.

20. The welded assembly of claim 19, further comprising:
a rotor shaft extending from the open-ended A-side through the B-side end plate and into a space defined collectively the B-side end plate and the collar.
